(19) United States
(12) Patent Application Publication
(10) Pub. No.: US 2017/0032796 A1
(43) Pub. Date: Feb. 2, 2017

(54) METHOD AND APPARATUS FOR DETERMINING IN A 2ND SCREEN DEVICE WHETHER THE PRESENTATION OF WATERMARKED AUDIO CONTENT RECEIVED VIA AN ACOUSTIC PATH FROM A 1ST SCREEN DEVICE HAS BEEN STOPPED

(71) Applicant: THOMSON LICENSING, Issy les Moulineaux (FR)

(72) Inventors: Peter Georg Baum, Hannover (DE); Xiao-Ming Chen, Hannover (DE); Michael Arnold, Isernhagen (DE); Ulrich Gries, Hannover (DE)

(21) Appl. No.: 15/302,483

(22) PCT Filed: Mar. 20, 2015
(86) PCT No.: PCT/EP2015/055911

§ 371 Date: Oct. 6, 2016

(30) Foreign Application Priority Data
Apr. 7, 2014 (EP) 14305504.4

(51) Int. Cl. G10L 19/018

(52) U.S. Cl. CPC G10L 19/018

(57) ABSTRACT

For determining in a 2nd screen whether or not watermarked audio content received from a 1st screen has been stopped, a watermark symbol detection in the received audio content and a related detection strength value determination is carried out. In case no watermark symbol has been detected, a received expected detection strength value is compared with a detection strength threshold value. If the expected detection strength value is greater than the detection strength threshold value, it is decided that content has been stopped in the 1st screen device. If not, it is decided that content has not been stopped in the 1st screen device. In case a watermark symbol has been detected, the detection strength value is compared with the expected detection strength value, a correspondingly updated detection strength threshold value is calculated, and it is decided that the content has not been stopped in the 1st screen device.

### TECHNICAL FIELD

The invention relates to a method and to an apparatus for determining in a 2nd screen device whether or not the presentation of audio content received via an acoustic path from a 1st screen device has been stopped or is paused, wherein the audio content was targeted to be watermarked.

### BACKGROUND

‘2nd Screen’ applications, for example for a portable device like a smart phone or a tablet showing content related to the video/audio content shown on a ‘1st screen’ like on a TV or in a cinema, are getting more and more attraction in the market. Such related content may be some background information and trivia about a movie shown, some e-commerce solutions or social media connections.

For showing relevant content the 2nd screen has to know what the 1st screen is currently playing, i.e. both devices need to be synchronised. Such synchronisation can be performed by standard PC connections like WLAN or Bluetooth, but this solution works only with newer TV sets and only after the user has carried out some set-up steps. Studies show that in some countries only 50% of network enabled TV sets are actually connected to a home network.

Instead, audio watermarking can be used for the synchronisation: synchronisation information like a content ID and a time code is embedded via watermarking inside the video/audio content itself. As long as a 1st screen device has watermarked audio output, a 2nd screen device comprising a microphone and a corresponding watermark detector can synchronise with every 1st screen device.

Related synchronisation technologies have, beside the basic task of identifying the currently played content including the associated time stamp, also to ensure that the application running on the 2nd screen device is notified when the content on the 1st screen has been paused or stopped. For watermarking technology the second task is quite difficult since watermark detection is depending strongly on the audio content and some content is not ‘watermark friendly’: for example it is not possible to inaudibly watermark silence. I.e., if the detector on the 2nd screen does not detect a watermark, it is not possible to determine whether the content has stopped on the 1st screen, or whether the content is still playing but due to silence in the audio content it is not possible to detect the watermarking. It is known to solve this problem by defining a time period: if no watermark is detected during this time period it is assumed that the audio content emitted from the 1st screen device has stopped.

### SUMMARY OF INVENTION

However, the problem with this known approach is that the application on the 2nd screen is not reactive enough if the time period chosen is long, and that the application stops unnecessarily if the time period chosen is short and the content contains for a longer period non-watermark-friendly parts.

This problem is solved by the method disclosed in claim 1.

An apparatus that utilises this method is disclosed in claim 2.

Advantageous additional embodiments of the invention are disclosed in the respective dependent claims.

In synchronising via audio watermarking a 2nd screen device or application with a main or 1st screen device like a TV, the invention is related to determining whether audio watermarking detection in the 2nd screen device is not possible due to non-watermark-friendly audio content, or due to the fact the content has stopped, e.g. due to user action or advertisements.

According to the invention, in the 2nd screen device watermark detector, additional information is used about which level of detection strength can be expected for a certain watermarking symbol. The corresponding detection strength level metadata is generated during or after the embedding process in a studio that produces the video/audio content supplied to the 1st screen device, and is loaded on the 2nd screen device before watermark detection. The advantage is that any 1st screen device (e.g. a facile TV receiver) on the market can be used for the inventive audio watermarking based synchronisation processing.

In case the 1st screen device has enough processing power it is also possible to generate the detection strength level metadata in the 1st screen device itself.

The 2nd screen watermark detector can then distinguish between sections of watermark ‘unfriendly’ audio content where low detection strength can be expected, and sections of watermark ‘friendly’ audio content where a high detection strength is expected. In case the watermark detector does not detect a symbol in watermark friendly content, the processing control decides that the presentation or replay of content from the 1st screen device has been stopped, whereas it decides to not stop but to continue trying to detect the watermark if no symbol can be detected in watermark unfriendly audio content.

An advantage of this kind of processing is significantly improved reactivity of the 2nd screen application: it is more quickly detected whether the user has stopped the content on the first screen or whether merely watermark ‘unfriendly’ content is played.

In principle, the inventive method is suited for determining in a 2nd device or application whether or not audio content received via an acoustic path from a 1st device or application has been stopped or is paused, wherein said audio content was targeted to be watermarked, said method including:
carrying out in said 2nd device or application a watermark symbol detection in the received audio content and a related detection strength value determination;
   in case no watermark symbol has been detected:
comparing a received expected detection strength value with a received detection strength threshold value;
if said expected detection strength value is greater than said detection strength threshold value, deciding that content has been stopped in the 1st screen device;
if said received expected detection strength value is not greater than said detection strength threshold value, deciding that content has not been stopped in the 1st screen device, and again carrying out said watermark symbol detection and said related detection strength value determination;
   in case a watermark symbol has been detected, comparing said determined detection strength value with said expected detection strength value and calculating therefrom a correspondingly updated detection strength threshold value which replaces said received detection strength threshold value;
   deciding that content has not been stopped in the 1st screen device, and again carrying out said watermark symbol detection and said related detection strength value determination.

In principle the inventive apparatus is suited for determining in a 2nd device or application whether or not audio content received via an acoustic path from a 1st device or application has been stopped or is paused, wherein said audio content was targeted to be watermarked, said apparatus including:

means being adapted for carrying out in said 2nd device or application a watermark symbol detection in the received audio content and a related detection strength value determination;
means being adapted for, in case no watermark symbol has been detected, comparing a received expected detection strength value with a received detection strength threshold value, and if said expected detection strength value is greater than said detection strength threshold value, for deciding that content has been stopped in the 1st screen device, and if said received expected detection strength value is not greater than said detection strength threshold value, for deciding that content has not been stopped in the 1st screen device and continuing the processing in said means for carrying out said watermark symbol detection and said related detection strength value determination;
means being adapted for comparing, in case a watermark symbol has been detected, said determined detection strength value with said expected detection strength value and for calculating therefrom a correspondingly updated detection strength threshold value which replaces said received detection strength threshold value, and for deciding that content has not been stopped in the 1st screen device and continuing the processing in said means for carrying out said watermark symbol detection and said related detection strength value determination.

### BRIEF DESCRIPTION OF DRAWINGS

Exemplary embodiments of the invention are described with reference to the accompanying drawings, which show in:

FIG. 1 inventive processing in the 2nd screen device;

FIG. 2 detection strength measurement in the 1st screen device;

FIG. 3 detection strength estimation in the 1st screen device;

FIG. 4 detection strength calculation for correlation based system.

### DESCRIPTION OF EMBODIMENTS

Even if not explicitly described, the following embodiments may be employed in any combination or sub-combination.

The invention is related to audio watermarking, in which watermarking information is inaudibly embedded in an audio data stream. The watermarking information is comprised of several bits, and a sequence of bits which can be independently decoded is called a payload. A typical payload size is 20 bits. Such payload is usually secured by an error correction code or processing. The resulting bits are embedded via watermarking symbols into the audio data stream. For example, one scheme is to use two symbols where one symbol denotes the bit value ‘0’ and the other one the bit value ‘1’.

According to the invention, in connection with watermark signal embedding the expected detection strength is determined. This can be performed by running a watermark detector possibly after some kind of modification of the audio signal (like adding noise), or the watermark detection strength can be estimated directly during embedding, for example by taking into account the embedding strength as determined by a psycho-acoustical model.

The expected detection strength for each watermarking symbol, an initial detection strength threshold value, and possibly some metadata like a content ID and the position of the symbols inside the content is then transferred to a second screen device. Often dedicated apps for each show are used for 2nd screen applications. That means that this detection strength information can be downloaded via Wi-Fi or via a mobile network together with the app, or the detection strength information can be loaded later by the app, for example at start-up time of the app or if the app has identified what kind of content is played on the first screen. Advantageously, loading of additional content is anyway used by the app and therefore the loading of detection strength information leads to no additional complexity in the app logic or on the backend server.

The 1st screen device may be a device without screen, e.g. a radio. The 2nd screen device may be a device without screen, e.g. a toy reacting to the content presented on the 1st device.

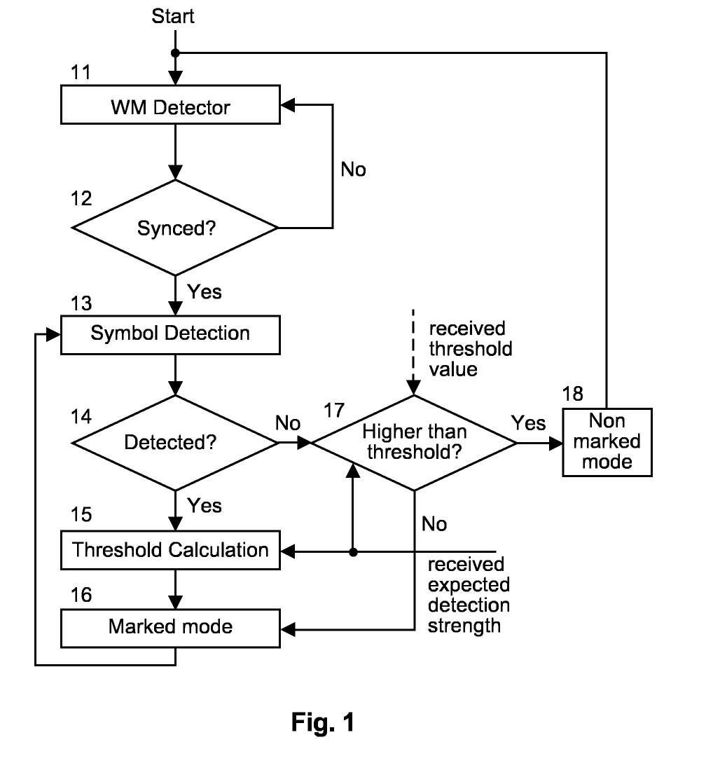

In FIG. 1, during content presentation or playback of content by the 1st screen device and audio signal output by at least one loudspeaker, the 2nd screen device or application receives via an acoustic path and at least one microphone the watermarked audio signal and is first synchronised via time stamps and/or content ID embedded in the audio track received from the 1st screen device. I.e., the values of the corresponding watermark symbols are evaluated. This kind of initial synchronisation processing is known. Since many movies or shows start with an easy-to-mark sound like title music or action scenes, this initial synchronisation is relatively easy. A watermark detector step or stage 11 receiving the possibly watermarked audio input signal is followed by a synchronisation step or stage 12. If no synchronisation is detected at a current time instant, step/stage 11 again tries to detect a watermarking for a following time instant. Following the initial synchronisation, the watermark detection processing continuously tries to detect watermark symbols. Downstream synchronisation step/stage 12, a symbol detection step or stage 13/14 is arranged. This step/stage detects whether or not a watermark symbol is present and determines the related detection strength value. In case no watermark symbol has been detected, the 2nd screen device compares in comparator step or stage 17 a received expected detection strength value for the watermark symbols with a received detection strength threshold value. The information about the expected detection strength and the detection strength threshold value is received together with the watermarked audio signal from the 1st screen device or via a separate reception path like the internet. If the expected detection strength value is greater than the detection strength threshold value it is clear (no watermark symbol has been detected in step/stage 14) that the presentation or replay of content has been stopped in the 1st screen device, it is decided in step or stage 18 that the present signal section is non-marked, the watermark detection processing goes into a re-sync mode (which means that for example a timeline of the content shown on the screen of the device is stopped), and the detector tries in step/stage 11/12 to re-synchronise.

The received expected detection strength may be different from the detection strength determined in step/stage 13/14 because the detection condition may not be the same as simulated during the calculation of the expected detection strength in a studio. For example, the acoustical environment may be different, or the level of disturbing environmental noise may be different from what has been expected in the studio. Therefore, if a watermark symbol has been detected (step/stage 13/14), the determined detection strength value is compared in step or stage 15 with the expected detection strength value and a correspondingly updated detection strength threshold value is calculated, below which updated threshold value safe symbol detection cannot be assumed. This updated detection strength threshold value replaces in step/stage 17 the received detection strength threshold value. Due to the watermark symbol detection in step/stage 13/14 it is clear in step or stage 16 that the current 1st screen device content is still playing, the symbol detection processing in step/stage 13/14 is continued, and the screen of the 2nd screen device is updated accordingly, for example by moving a content timeline.

The detection strength may be expressed as a real value between ‘0’ and ‘1’, where ‘0’ means that the symbol cannot be detected whereas with strength ‘1’ the symbol can easily be detected. For instance, the expected detection strength of a symbol may be 0.8, but the detection strength with which the symbol is detected in the 2nd screen device in the current environment may be 0.5 which is 0.3 smaller than 0.8. This in turn means that a symbol with expected detection strength of 0.3 has real detection strength of about 0.0 and is thus not detectable, i.e. the detector is in this case not able to tell whether or not watermarked content is received. To be on the safe side, a smaller margin of 0.1 can be added and the final detection strength threshold value is thus 0.3+0.1=0.4. This means that all watermark symbols with expected detection strength of more than 0.4 can be detected in the 2nd screen device in the current environment.

If in step/stage 17 the expected detection strength value is not greater than the detection strength threshold value, it still cannot be decided whether the presentation or replay of content has been stopped or whether the combination of content and detection environment led to the detection miss. Therefore it is assumed in step or stage 16 that the current 1st screen device content is still playing and that the currently received audio signal from the 1st screen device is correspondingly watermarked. The symbol detection processing in step/stage 13/14 is continued and the screen of the 2nd screen device is updated accordingly, for example by moving a content timeline.

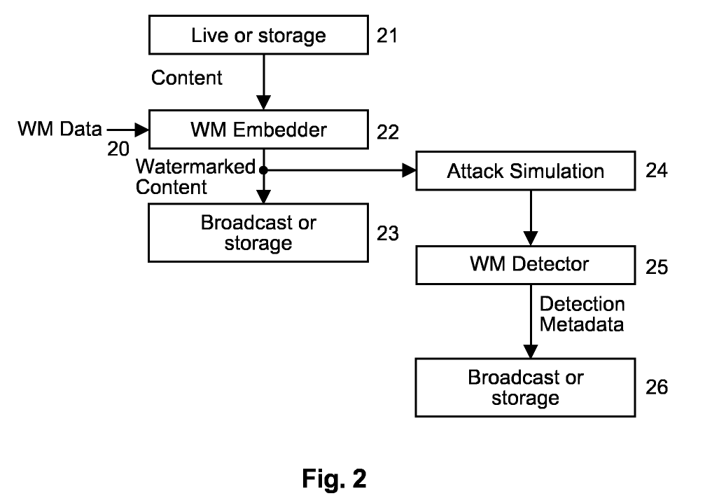

FIG. 2 shows a detection strength measurement for example in a studio or in a central service provider. Content 21 (i.e. audio data) from a live data stream or from stored data is input to a watermark embedding step or stage 22. Watermark information data 20 are embedded in embedder 22 into the content 21. The resulting watermarked content is broadcast or streamed, or is fed to a data storage 23. It is also supplied to an attack simulation step or stage 24, which somehow simulates the signal deterioration of an acoustic path between a 1st screen device and a 2nd screen device, e.g. by simply adding noise. The output of step/stage 24 passes through a watermark detector step or stage 25, which determines watermark detection strength values and a watermark detection strength threshold value, and provides corresponding detection metadata (possibly including corresponding time code data) for broadcast or streaming, or to storage step or stage 26.

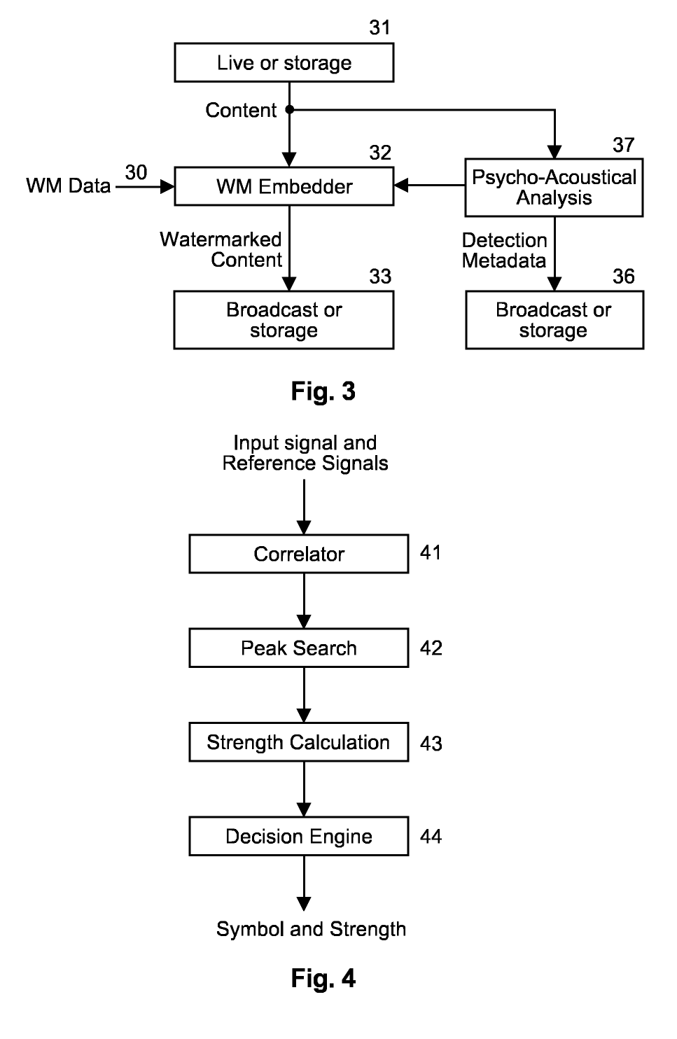

FIG. 3 shows detection strength estimation for example in a studio or in a central service provider. Content 31 (i.e. audio data) from a live data stream or from stored data is input to a watermark embedding step or stage 32 and to a psycho-acoustical analysis step or stage 37. Psycho-acoustical analysis step/stage 37 performs a psycho-acoustical analysis of the current audio signal and determines therefrom at which locations and/or with which strength watermark symbols from watermark information data can be embedded in embedder 32 into the audio content 31, and determines therefrom watermark detection strength values and a watermark detection strength threshold value. The resulting watermarked content is broadcast or streamed, or is fed to a data storage 33. Step/stage 37 generates corresponding detection metadata (possibly including corresponding time code data) which is broadcast or streamed, or is fed to a storage step or stage 36.

FIG. 4 shows a detection strength calculation for a correlation based system. A current input signal and required reference signals are fed to a correlator 41 which correlated an input signal section with a reference signal. In the corresponding correlation result values a downstream peak search step or stage 42 carries out a correlation result peak search. Using the peak or peaks found, in step or stage 43 the related detection strength is calculated, and in a decision step or stage 44 the corresponding watermark symbol is selected and is output together with the related detection strength value.

Details for detection strength determination and for detection strength threshold value calculation are described e.g. in WO 2007/031423 A1, EP 2081188 A1, EP 2175444 A1 and WO 2011/141292 A1.

Advantageously, only the expected detection strength is required in the watermark detection processing at 2nd screen side, not the watermark symbol values as such during the normal operation. Since the expected detection strength is for many audio watermarking systems mostly independent on the watermark symbol value, it is possible to use the inventive processing even in workflows in which it is not possible to send the expected detection strength information to the 2nd screen device after the final embedding has been done. In other words, the invention can be carried out in a two-step process: in a first step the detection strength is estimated and the gathered information stored in, or transmitted to, the 2nd screen device. In a second step the ‘real’ embedding is done and the final watermarking data is written into the audio stream.

In case for a longer period no watermark presence detection is possible due to significant noise or microphone signal deterioration, for example if a vacuum cleaner is operated in the living room, after that period a re-synchronisation of the 2nd screen device is required, for which re-synchronisation initially the content of the received watermark symbols is evaluated. Following synchronisation, it is again sufficient to merely detect the presence or absence of watermark symbols.

The inventive processing can be used for ‘nearly live’ content, which means that the content is to be analysed and the metadata is to be transmitted to the end user. This will take some seconds. If the live signal is delayed by some seconds, the inventive processing will work, too.

Advantageously, the inventive processing operates very fast, so that it can be applied even after ‘last minute’ changes in the audio content. Such last minute changes do not pose a problem, if the audio content is ‘watermark friendly’ at that time.

In case of trick mode play in the 1st screen device there are two possibilities. If the watermark detection works well in the 2nd screen device, by reading the watermarks the metadata can be easily re-synchronised. If not, the situation is basically the same as the situation at the beginning of a detection: the detector is waiting for ‘good’ watermarks to be able to synchronise the metadata and playing content.

The inventive processing can be carried out by a single processor or electronic circuit, or by several processors or electronic circuits operating in parallel and/or operating on different parts of the inventive processing.

1. Method for determining in a 2nd device or application whether or not audio content received via an acoustic path from a 1st device or application has been stopped or is paused, wherein said audio content was targeted to be watermarked, said method including:
carrying out in said 2nd device or application a watermark symbol detection in the received audio content and a related detection strength value determination;
in case no watermark symbol has been detected:
comparing a received expected detection strength value with a received detection strength threshold value;
if said expected detection strength value is greater than said detection strength threshold value, deciding that content has been stopped in the 1st screen device;
if said received expected detection strength value is not greater than said detection strength threshold value, deciding that content has not been stopped in the 1st screen device, and again carrying out said watermark symbol detection and said related detection strength value determination;
in case a watermark symbol has been detected, comparing said determined detection strength value with said expected detection strength value and calculating therefrom a correspondingly updated detection strength threshold value which replaces said received detection strength threshold value;
deciding that content has not been stopped in the 1st screen device, and again carrying out said watermark symbol detection and said related detection strength value determination.

2. Apparatus for determining in a 2nd device or application whether or not audio content received via an acoustic path from a 1st device or application has been stopped or is paused, wherein said audio content was targeted to be watermarked, said apparatus including:
means being adapted for carrying out in said 2nd device or application a watermark symbol detection in the received audio content and a related detection strength value determination;
means being adapted for, in case no watermark symbol has been detected, comparing a received expected detection strength value with a received detection strength threshold value, and if said expected detection strength value is greater than said detection strength threshold value, for deciding that content has been stopped in the 1st screen device, and if said received expected detection strength value is not greater than said detection strength threshold value, for deciding that content has not been stopped in the 1st screen device and continuing the processing in said means for carrying out said watermark symbol detection and said related detection strength value determination;
means being adapted for comparing, in case a watermark symbol has been detected, said determined detection strength value with said expected detection strength value and for calculating therefrom a correspondingly updated detection strength threshold value which replaces said received detection strength threshold value, and for deciding that content has not been stopped in the 1st screen device and continuing the processing in said means for carrying out said watermark symbol detection and said related detection strength value determination.

3. Method according to claim 1, wherein information about said received expected detection strength and said received detection strength threshold value is provided together with the watermarked audio signal from the 1st screen device.

4. Method according to claim 1, wherein information about said received expected detection strength and said received detection strength threshold value is provided via a separate reception path.

5. Method for generating in a studio or at a service provider site expected watermark detection strength data and detection strength threshold data for watermark symbols embedded in an audio signal, said method including:
embedding watermark symbol data into said audio signal;
providing a correspondingly watermarked audio signal;
deteriorating said watermarked audio signal so as to simulate a deterioration of said watermarked audio signal after having been transmitted via an acoustic path;
performing a watermark symbol detection and providing corresponding watermark detection strength values and a corresponding watermark detection strength threshold value.

6. Method according to claim 5, wherein said deteriorating of said watermarked audio signal is performed by adding noise.

7. Method for generating in a studio or at a service provider site expected watermark detection strength data and detection strength threshold data for watermark symbols embedded in an audio signal, said method including:
embedding watermark symbol data into said audio signal;
providing a correspondingly watermarked audio signal;
performing a psycho-acoustical analysis of said watermarked audio signal so as to determine with which strength watermark symbols can be embedded into said audio signal, and to estimate therefrom corresponding watermark detection strength values and a corresponding watermark detection strength threshold value;
providing said watermark detection strength values and a said watermark detection strength threshold value.

8. Apparatus according to claim 2, wherein information about said received expected detection strength and said received detection strength threshold value is provided together with the watermarked audio signal from the 1st screen device.

9. Apparatus according to claim 2, wherein information about said received expected detection strength and said received detection strength threshold value is provided via a separate reception path.
